(19) United States
(12) Patent Application Publication
(10) Pub. No.: US 2008/0286602 A1
(43) Pub. Date: Nov. 20, 2008

(54) HEAT CONDUCTOR

(75) Inventor: Tsuyoshi Hasegawa, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/117,188

(22) Filed: May 8, 2008

(30) Foreign Application Priority Data
May 16, 2007 (JP) 2007-130968

(51) Int. Cl. B32B 15/20

(52) U.S. Cl. 428/634

(57) ABSTRACT

A heat conductor that improves heat conductivity is provided. The heat conductor has a first heat conductive region and a second heat conductive region. The first heat conductive region is configured by lamination of a first metal member and a graphite member. The second heat conductive region is configured by lamination of the first metal member and a second metal member.

### CROSS REFERENCE TO RELATED APPLICATION

This application is based upon and claims the benefit of priority from Japanese Patent Application No. 2007-130968, filed on May 16, 2007, the entire contents of which are incorporated herein by reference.

### FIELD OF THE INVENTION

This invention relates to a heat conductor used for controlling heat dissipation of a heating element, such as various kinds of electronic components.

### DESCRIPTION OF THE BACKGROUND

Generally, a lamination of metal sheets and graphite sheets, which have better thermal conductivity than metals, are proposed for a heat conductor, since heating value is increasing due to higher electric power capacity of heating elements such as an electronic component. A heat conductor with an excellent thermal conductivity is desired.

Japanese patent laid-open publication No. 2001-144237 describes a graphite sheet lamination heat conductor having a laminated structure of graphite sheets and metal foils. Graphite has an excellent thermal or heat conductivity characteristic as compared with metal. In this graphite sheet lamination heat conductor, because of the graphite sheet, its weight can be reduced, and it becomes possible to radiate heat efficiently by raising the thermal conductivity in the sheet plane direction of the graphite sheet lamination heat conductor.

However, in the above-mentioned heat conductor, the thermal conductivity of the graphite sheet in the direction perpendicular to the sheet plane is inferior to that in the sheet plane direction, and the thermal conductivity in the direction perpendicular to the plane at a heat-receiving portion, for example, is inferior. For this reason, it has been difficult to cope with a high density mounting of electronic components and an acceleration of increasing output power, which are strongly demanded recently.

### SUMMARY OF THE INVENTION

There is provided a heat conductor having a first heat conductive region and a second heat conductive region. The first heat conductive region is configured by a lamination of a first metal member and a graphite member. The second heat conductive region is configured by a lamination of the first metal member and a second metal member.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a cross-sectional view of a main portion of a heat conductor according to the first embodiment.

FIG. 2 is an exploded perspective view of the heat conductor shown in FIG. 1.

FIG. 3 is an exploded perspective view illustrating a main portion of a heat conductor according to a second embodiment.

FIG. 4 is an exploded perspective view illustrating a main of a heat conductor according to a third embodiment.

FIG. 5 is an exploded perspective view illustrating a main portion of a heat conductor according to a fourth embodiment.

FIG. 6 is a cross-sectional view illustrating a main portion of a heat conductor according to a fifth embodiment.

FIG. 7 is an exploded perspective view illustrating the heat conductor shown in FIG. 6.

FIG. 8 is a cross-sectional view illustrating showing a main portion of a heat conductor according to a sixth embodiment.

FIG. 9 is an exploded perspective view illustrating the heat conductor shown in FIG. 8.

### DETAILED DESCRIPTION OF THE INVENTION

Now, embodiments will be explained in detail with reference to the drawings. According to the embodiments described herein, a heat conductor includes a plurality of first metal members, a plurality of second metal members, a plurality of graphite members. The heat conductor also includes a first heat conductive region and a second heat conductive region. The first heat conductive region is configured by a lamination of the first metal members and the graphite members. The second heat conductive region is configured by a lamination of the first metal members and the second metal members.

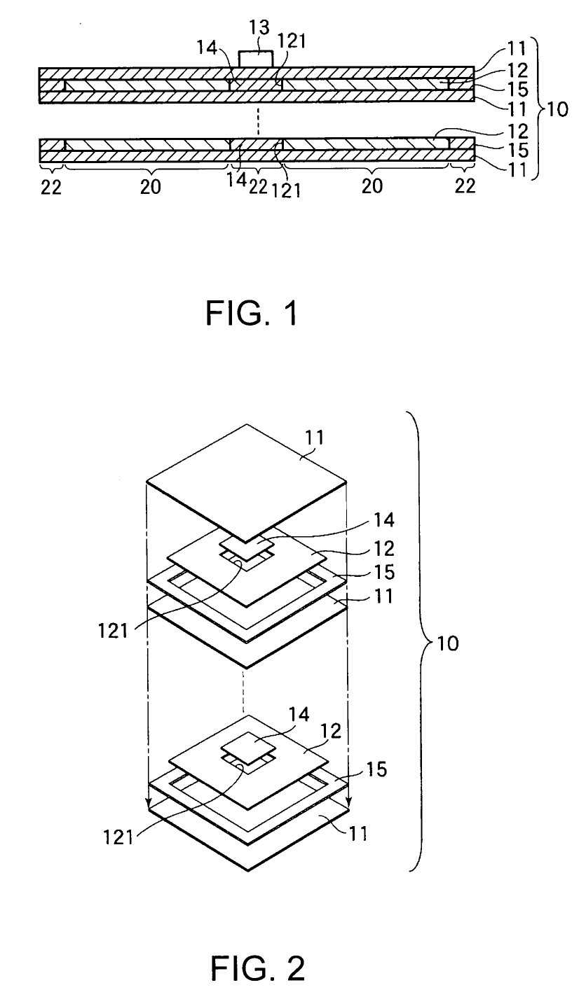

As shown in FIG. 1, heat conductor 10 according to the first embodiment has, for example, two or more first metal members 11 and two or more graphite members 12 in a laminated form so that each graphite member 12 is inserted between first metal members 11. In this embodiment, first metal member 11 is formed from a copper foil, for example, and graphite member 12 is formed by a lamination of two or more graphite sheets, for example.

As shown in FIG. 2, each graphite member 12 is bored with a square aperture 121 at the center, for example. Metal sheet 14, which forms a second metal member and is made of copper, for example, is provided in aperture 121 so that a surface of metal sheet 14 and a surface of graphite member 12 constitute a same, even surface.

Frame shaped metal sheet 15, which forms the second metal member and is made of copper foil, for example, is attached to a periphery of graphite member 12 so that a surface of frame shaped metal sheet 15 and the surface of graphite member 12 constitute a same surface. Metal sheet 14 and frame shaped metal sheet 15, which form the second metal members, are located between first metal members 11. Thereby, first metal members 11 are thermally connected via metal sheet 14 and frame shaped metal sheet 15, which are the second metal member.

First metal member 11, graphite member 12, metal sheet 14 and frame shaped metal sheet 15 are stacked and are subjected to pressurization and heating, for example, and thereby first metal member 11, metal sheet 14 and frame shaped metal sheet 15 are integrated by so called diffusion bonding, and first metal member 11 and graphite member 12 contact each other, and thus heat conductor 10 is manufactured.

Here, first metal member 11 is copper and 0.1 mm in thickness, graphite member 12 is 0.1 mm in thickness. Both metal sheet 14 and frame shaped metal sheet 15 are copper and 0.1 mm in thickness, respectively.

Heat conductor 10 includes first heat conductive region 20 and second heat conductive region 22. In first heat conductive region 20, first metal member 11 and graphite member 12 are laminated and thermally coupled. In second heat conductive region 22, first metal member 11 and the second metal member, which is formed by metal sheet 14 and frame shaped metal sheet 15, are laminated and thermally coupled. First heat conductive region 20 and second heat conductive region 22 are adjacently positioned.

Second heat conduction region 22 containing metal sheet 14 serves as a region which heating element 13, for example, electronic parts, is mounted on. When heat conductor 10 is used, heating element 13 is mounted on and thermally coupled to the topmost metal member 11.

According to above-mentioned structure, in heat conductor 10, if a heat from heating element 13 mounted on metal member 11 of second heat conductive region 22 transfers to metal member 11, the heat is diffused effectively to vertical direction to the plane through first metal member 11 and metal sheet 14 and frame shaped metal sheet 15, which form the second metal members. Metal member 11, metal sheet 14 and frame shaped metal sheet 15 have excellent thermal conductivities in vertical direction to the plane as compared with that of the graphite member 12.

Simultaneously the heat transferred to first metal member 11 transfers to graphite member 12, which has the excellent thermal conductivity in the plane direction, via first metal member 11 and metal sheet 14 and frame shaped metal sheet 15, which form the second metal members, and the heat diffuses effectively to the plane direction in graphite member 12. The heat transferred to graphite member 12, is diffused to lower graphite members 12 via first metal members 11 and is diffused to the plane direction in order and is conducted to whole heat conductor 10 uniformly.

According to this embodiment, heat diffusion in the plane direction is performed efficiently by graphite member 12 which is excellent in the heat conduction property in the plane direction as compared with that of first metal member 11. Heat diffusion in vertical direction to the plane is performed efficiently by first metal member 11, and metal sheet 14 and frame shaped metal sheet 15, which form the second metal member. First metal member 11, metal sheet 14 and frame shaped metal sheet 15 are excellent in the heat conduction property in the vertical or perpendicular direction to the plane direction as compared with than of the graphite sheet 12.

Thereby, the heat transferred to metal member 11 from heating element 13 is conducted to whole heat conductor 10 uniformly and quickly.

As a result, the heat conductor with the excellent thermally conductive ability, which uses the whole of the heat conductor uniformly, can be formed, and it becomes possible to realize a high efficient thermal control.

In the above-mentioned embodiment, since first heat conductive region 20 is surrounded by second heat conductive region 22, that is, because of a structure that an edge of graphite member 12 is not exposed by frame shaped metal sheet 15, mechanically weak graphite member 12 can be protected. In the above-mentioned embodiment, second conductive region 22 is divided into plural regions, for example two regions, by first conductive region 20, where one region corresponds to metal sheet 14 and the other region corresponds to frame shaped metal sheet 15. In this embodiment, a number of aperture 121 provided with graphite member 12 is not limited one, two or more is available and metal sheets 14 are arranged in the apertures 121 respectively.

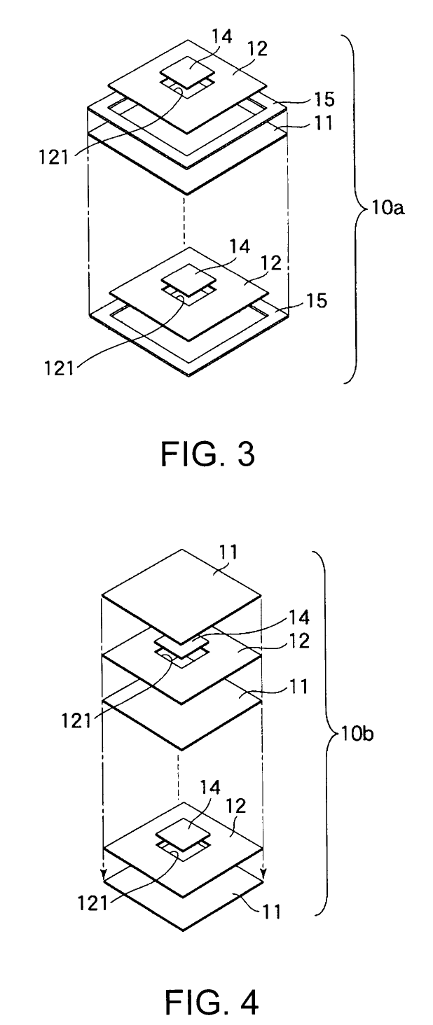

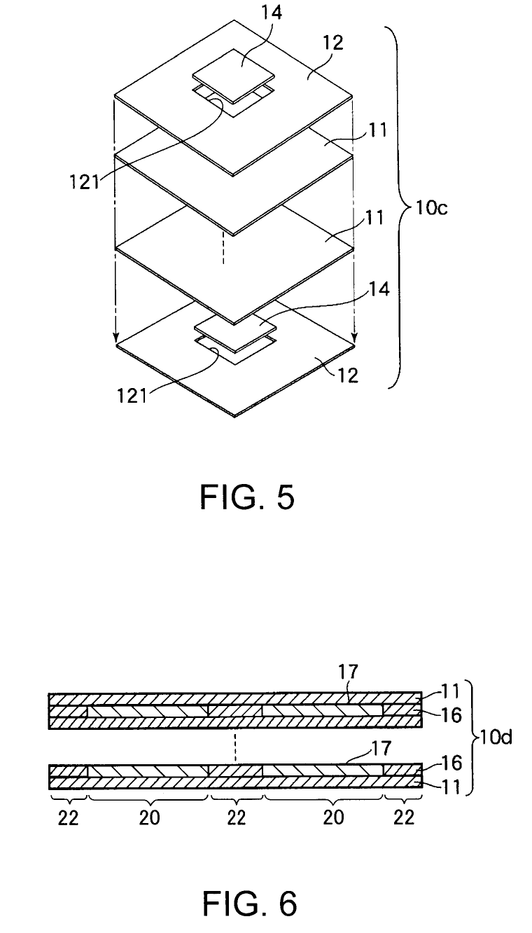

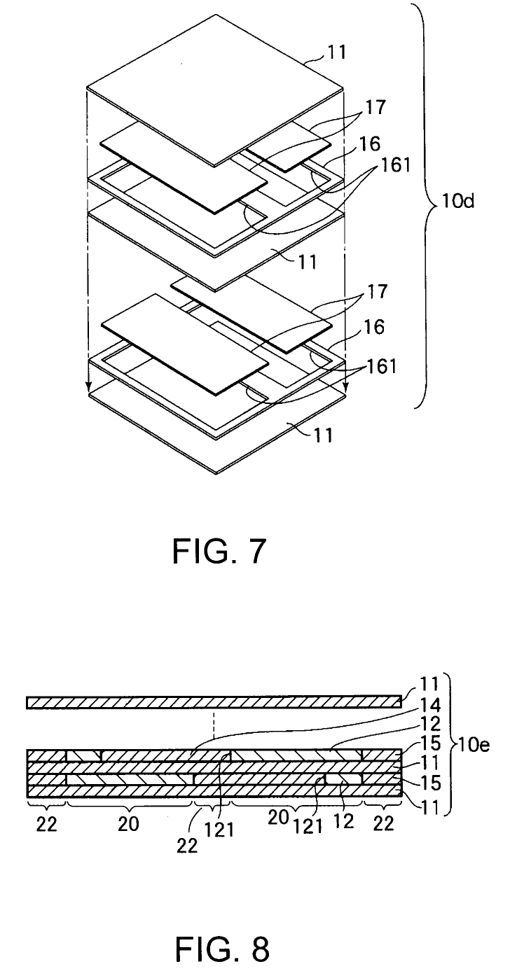

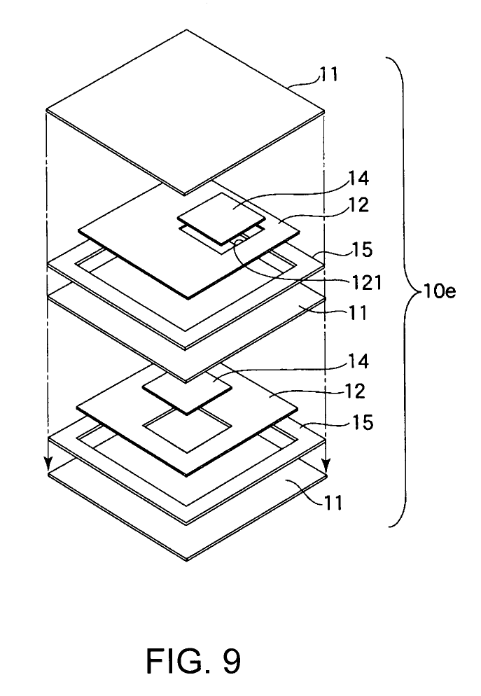

This invention is not limited to the above-mentioned embodiment, and other embodiments of the heat conductor are illustrated as heat conductors 10a, 10b, 10c, 10d, and 10e in FIG. 3, FIG. 4, FIG. 5, FIG. 6, FIG. 7, FIG. 8 and FIG. 9. The embodiments shown in FIGS. 3-9 will be explained next. In FIGS. 3-9, the same numerals denote the same portions illustrated in FIG. 1 and FIG. 2, and detailed explanations of those elements are omitted.

FIG. 3 shows a heat conductor according to the second embodiment. In heat conductor 10a, topmost metal member 11 and lowermost metal member 11 shown in FIG. 1 and FIG. 2 are not provided and graphite members 12, which are attached with frame shaped metal sheets 15 at periphery and metal sheets 14 in apertures 121, are provided at a topmost part and at a lowermost part. As a modification of this embodiment, heat conductor 10a may have first metal member 11 at the lowermost part or at the topmost part, and graphite member 12 may be exposed at the other part.

FIG. 4 shows a heat conductor according to the third embodiment. Heat conductor 10b does not have frame shaped metal sheet 15 attached to a periphery of graphite member 12 shown in FIGS. 1 and 2, and thereby a peripheral edge of graphite member 12 is exposed.

FIG. 5 shows a heat conductor according to the fourth embodiment. In heat conductor 10c, graphite sheets 12 is exposed directly at a topmost part and at a lowermost part without first metal members 11 arranged at the topmost part and at the lowermost part of heat conductor 10b shown in FIG. 4. As a modification of this embodiment, heat conductor 10c may have first metal member 11 at one of the lowermost part and the topmost part, and the graphite sheet 12 may be exposed at the other part.

FIGS. 6 and 7 show a heat conductor according to the fifth embodiment. In heat conductor 10d, frame shaped metal sheet 16, which is second metal member, has two apertures 161 separated each other and graphite members 17, which are made of graphite sheets, for example, are attached in aperture 161 respectively. Heat conductor 10d is formed by laminating a plurality of frame shaped metal sheets 16 with two graphite members 17 disposed separately each other and a plurality of first metal members 11 so that frame shaped metal member 17 is interposed between first metal members 11.

In other words, in heat conductor 10d, two graphite members 17 are separately arranged in two apertures 161 of frame shaped metal sheet 16. Thereby, first heat conductive region 20, which includes a lamination of first metal member 11 and graphite member 17, is divided into plural regions by second conductive region 22, which includes a lamination of first metal member 11 and the second metal member. In this embodiment, a number of aperture 161 provided with frame shaped metal sheet 16 is not limited two, three or more is available and graphite members 17 are arranged in the apertures 161 respectively. Also in this embodiment, graphite member 12 may be exposed without providing first metal member 11 at least one of at an upper surface and at a lower surface of heat conductor 10d.

FIGS. 8 and 9 show a heat conductor according to the sixth embodiment. In heat conductor 10e, a position of aperture 121 formed with graphite member 12 is shifted in order, for example, in a predetermined direction, and thereby a position of metal sheet 14, which is the second metal member and are received in aperture 121, is shifted between adjacent graphite sheets 12 via first metal member 11. Thus, apertures 121 are positioned in a stagger pattern. Thereby two metal sheets 14, which are the second metal member and are received in apertures 121 of adjacent two graphite members 12 via first metal member 11, are connected and arranged in stairs shape. Also in this embodiment, graphite member 12 may be exposed without providing first metal member 11 at least one of at a lowermost part and at a topmost part of heat conductor 10e.

In above-mentioned embodiments, a number of the laminated layer of the first metal member and the graphite member with the second metal member, which is the metal sheet and the frame shaped metal member, is not limited, if two or more. Moreover, the graphite member itself may be made of, for example, a lamination of a plurality of graphite sheets in layers, or graphite powder. Although the first metal member and the second metal member are formed of copper in above-mentioned embodiments, the first metal member and the second metal member may be formed of aluminum, copper alloy and aluminum alloy, and similar effect are obtained in those case.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A heat conductor, comprising:
a first heat conductive region configured by a lamination of a first metal member and a graphite member, and
a second heat conductive region configured by a lamination of the first metal member and a second metal member.

2. The heat conductor according to claim 1, wherein the second heat conductive region is divided into plural regions by the first heat conducting region.

3. The heat conductor according to claim 1, wherein the first heat conductive region has the first metal member provided at one surface of the first heat conductive region.

4. The heat conductor according to claim 1, wherein the first heat conductive region is divided into plural regions by the second heat conductive region.

5. The heat conductor according to claim 1, wherein the first heat conductive region is surrounded by the second heat conductive region.

6. The heat conductor according to claim 1, wherein the first metal member is made of copper.

7. The heat conductor according to claim 6, wherein the second metal member is made of copper.

8. The heat conductor according to claim 1, wherein the first metal member and the second metal member in the second heat conductive region are bonded by diffusion.

9. The heat conductor according to claim 1, wherein the first heat conductive region is provided adjacent to the second heat conductive region.

10. The heat conductor according to claim 1, wherein the graphite member and the second metal member in the first heat conductive region form even surface.

11. The heat conductor according to claim 1, wherein the graphite member has an aperture and second metal members is arranged in the aperture of the graphite member.

12. The heat conductor according to claim 11, wherein two of the graphite members are provided adjacent to the first metal member, and the apertures are positioned in a stagger pattern.

13. The heat conductor according to claim 1, wherein the second metal member has an aperture and the graphite member is arranged in the aperture of the second member.

14. The heat conductor according to claim 13, wherein the second metal member has two or more apertures and the graphite members are arranged in the apertures of the second metal member.

15. The heat conductor according to claim 11, wherein the graphite member and the second metal member are arranged between the first metal members.

16. A heat conductor, comprising:
a plurality of first metal members;
a plurality of second metal members; and
a plurality of graphite members;
wherein a first heat conductive region is configured by a lamination of the first metal members and the graphite members, and a second heat conductive region is configured by a lamination of the first metal members and the second metal members.
